(19) United States
(12) Patent Application Publication
(10) Pub. No.: US 2005/0162582 A1
(43) Pub. Date: Jul. 28, 2005

(54) Liquid crystal display

(75) Inventors: Takaaki Kitada, Ooamishirasato (JP); Seiichi Nishiyama, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/038,233

(22) Filed: Jan. 21, 2005

(30) Foreign Application Priority Data
Jan. 22, 2004 (JP) 2004-014527

(51) Int. Cl. G02F 1/1333; G02F 1/1335

(52) U.S. Cl. 349/58; 349/61

(57) ABSTRACT

There is disclosed a liquid crystal display including cold cathode fluorescent tubes having improved failure resistance and shock resistance. The liquid crystal display has a liquid crystal panel and a backlight disposed on the opposite side of the display screen of the liquid crystal panel. The backlight has plural light sources and plural lamp holders for holding the light sources. Each of the lamp holders has a pair of gripping portions for gripping the light sources and a connector portion having the gripping portions at its opposite ends. The connector portion has slits in its opposite end portions, the slits extending in the longitudinal direction of the connector portion.

### BACKGROUND OF THE INVENTION

1. Field of the Invention

The present invention relates to a liquid crystal display and, more particularly, to techniques effectively applied to a liquid crystal display having a right under type backlight.

2. Description of the Related Art

Liquid crystal display modules are widely used as display devices for personal computers, monitors, television receivers, and so on. Such a liquid crystal display module is made up of a liquid crystal panel and a backlight for illuminating the panel. A drain driver and a gate driver are arranged around the panel. Backlights of this construction are classified into two major categories: side-light type backlight and right under type backlight. Liquid crystal display modules used as display devices for notebook personal computers mainly adopt side-light type backlights.

In recent years, liquid crystal display modules have been increased in size to achieve larger display screens. Such large liquid crystal display modules are also used as monitor displays. The right under type backlight capable of producing high brightness is adapted for such large liquid crystal display modules used as monitor displays with large screen size. In a large liquid crystal display module having a large display screen and adapted to be used as a monitor display, the cold cathode fluorescent tube (CFL) used as the backlight is inevitably increased in length. Furthermore, as the inside diameter of the CFL is reduced, the emission efficiency is improved. Therefore, it is required that the tube be lengthened and, at the same time, be thinned.

Consequently, in a large liquid crystal display module having a large display screen and adapted to be used as a monitor display, the mechanical strength of the cold cathode fluorescent tube (CFL) alone used as a backlight is very small. Especially, the CFL is vulnerable to bending.

As a backlight free of this problem, a right under type backlight in which an intermediate portion of a cold cathode fluorescent tube (CFL) is held by a lamp holder is known (see Patent Reference 1 below).

There exists a prior art reference associated with the invention of the subject application as follows.

[Patent Reference 1] JP-A-2001-210126

However, in the right under type backlight described in the above-cited Patent Reference 1, the cold cathode fluorescent tube (CFL) is held by lamp holders. Therefore, when an impact is applied under some conditions (e.g., product impact test) there is the problem that the cold cathode fluorescent tube (CFL) is damaged or broken by application of an external force from the lamp holders.

### SUMMARY OF THE INVENTION

The present invention has been made to solve the aforementioned problems with the prior art technique. It is an object of the present invention to provide techniques for improving the failure resistance of the cold cathode fluorescent tubes of a liquid crystal display to thereby improve the shock resistance.

The foregoing and other features of the present invention and novel features thereof will become apparent from the description of the present specification and from the accompanying drawings.

Typical aspects of the present invention disclosed herein are briefly described below.

One aspect of the invention lies in a liquid crystal display comprising a liquid crystal panel having a display screen and a backlight disposed on the opposite side of the display screen of the panel. The backlight has plural light sources and plural lamp holders for holding the light sources. Each of the lamp holders has gripping portions for gripping the light sources. A shock-absorbing material is formed on the surfaces of the gripping portions making contact with the light sources.

In another aspect of the invention, resilience is imparted to the lamp holders themselves by providing a connector portion having the gripping portions at its opposite ends and forming slits or holes in both ends of the connector portion.

In a further aspect of the invention, a support portion for supporting an optical element is formed on the connector portion.

The advantages derived by typical aspects of the invention disclosed herein are briefly described below.

In the liquid crystal display of the present invention, the failure strength of the cold cathode fluorescent tubes can be improved and thus the shock resistance can be improved.

### BRIEF DESCRIPTION OF THE DRAWINGS

FIG. 1 is an exploded perspective view schematically showing the structure of a liquid crystal display module according to embodiment 1 of the present invention.

FIG. 2 is an expanded view schematically showing the structure of the right under type backlight (BL) shown in FIG. 1.

FIG. 3 is an enlarged view of portion A of FIG. 2.

FIG. 4A is a perspective view of one lamp holder of embodiment 1 of the invention.

FIG. 4B is a front elevation of one lamp holder of embodiment 1 of the invention.

FIG. 4C is a side elevation of one lamp holder of embodiment 1 of the invention.

FIG. 5A is a perspective view of one lamp holder of embodiment 2 of the invention.

FIG. 5B is a front elevation of one lamp holder of embodiment 2 of the invention.

FIG. 5C is a side elevation of one lamp holder of embodiment 2 of the invention.

FIG. 6 is a view illustrating another example of method of mounting lamp holders in embodiments of the invention.

FIG. 7A is a perspective view of the prior art lamp holder.

FIG. 7B is a front elevation of the prior art lamp holder.

FIG. 7C is a side elevation of the prior art lamp holder.

### DESCRIPTION OF THE PREFERRED EMBODIMENTS

Embodiments of the present invention are hereinafter described in detail with reference to the accompanying drawings. Those components which have the same functions are indicated by same reference numerals throughout all the figures; repetition of the same description is avoided.

### Embodiment 1

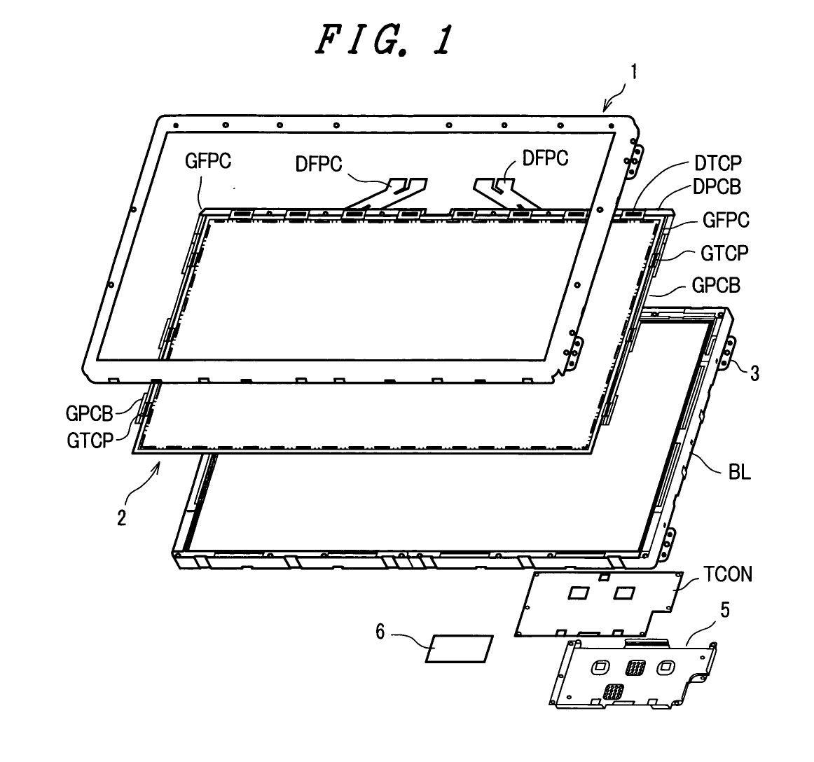

FIG. 1 is an exploded perspective view schematically showing the configuration of a liquid crystal display module of embodiment 1 of the present invention. As shown in this figure, the liquid crystal display module of the present embodiment is made up of a frame-like member or upper frame 1 made of a metal plate, a liquid crystal panel 2, and a backlight (BL). The upper frame 1 may also be referred to as the shield case, upper case, or upper metal frame.

The liquid crystal panel 2 has a pair of substrates, a drain printed circuit board (DPCB) arranged around the substrates, and two gate printed circuit boards (GPCBs). A liquid crystal layer is sandwiched between the substrates, which are made of a material having optical transparency and electrical insulation such as glass.

Tape carrier packages (DTCP and GTCP) are mounted on the printed circuit boards. Plural sets of liquid crystal-driving semiconductor integrated circuit elements forming driver ICs are Tape-Automated-Bonded (TAB) to the tape carrier packages.

In addition, there are a flexible circuit board (DFPC) for supplying signals or electric power to these driver ICs and a connector flexible circuit board (GFPC) for connecting the drain circuit board (DPCB) and gate circuit boards (GPCBs).

The liquid crystal panel 2 is constructed by stacking the pair of substrates over top of each other with a given spacing therebetween, bonding together the substrates by a sealing material formed like a frame near the fringes of the space between the substrates, introducing a liquid crystal inside the sealing material between the substrates from a liquid crystal sealing port formed in a part of the sealing material, hermetically sealing off the liquid crystal, and bonding polarizing plates to the outsides of the substrates.

The flexible circuit board (DFPC) is wired to a printed circuit board (Tcon) mounted on the underside of the backlight (BL), the circuit printed board (Tcon) having integrated circuit elements such as a timing converter.

Also shown in FIG. 1 are a cover 5 for the circuit board (Tcon) and a label 6. As shown in FIG. 1, the upper frame 1 made of a metal plate is disposed over the assembled liquid crystal panel 2 such that its display window permits the main surface corresponding to the effective display area of the liquid crystal panel 2 to be exposed. Accordingly, the upper frame 1 has a frame-like planar structure.

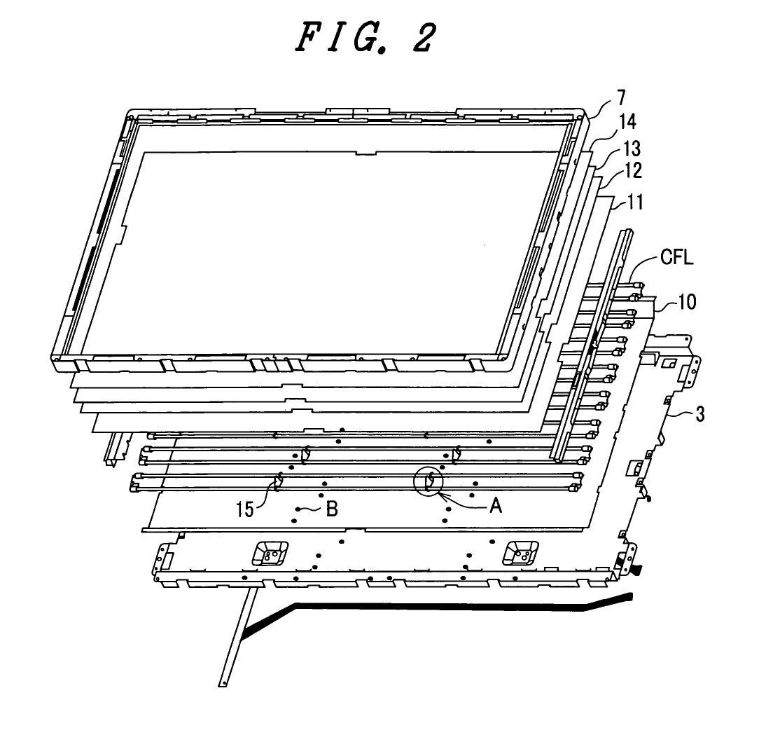

FIG. 2 is an expanded view schematically showing the structure of the right under type backlight (BL) shown in FIG. 1. As shown in FIG. 2, the right under type backlight (BL) shown in FIG. 1 has a part 7 molded from synthetic resin and a lower frame 3 made of a metal. A reflecting plate 10, plural cold cathode fluorescent tubes (CFLS), a diffuser plate 11, a lower diffuser sheet 12, a prism sheet 13, and an upper diffuser sheet 14 are arranged in the order shown in FIG. 2.

A liquid crystal display module is completed by placing the assembled liquid crystal panel 2 between the upper frame 1 and the backlight (BL) and fastening them.

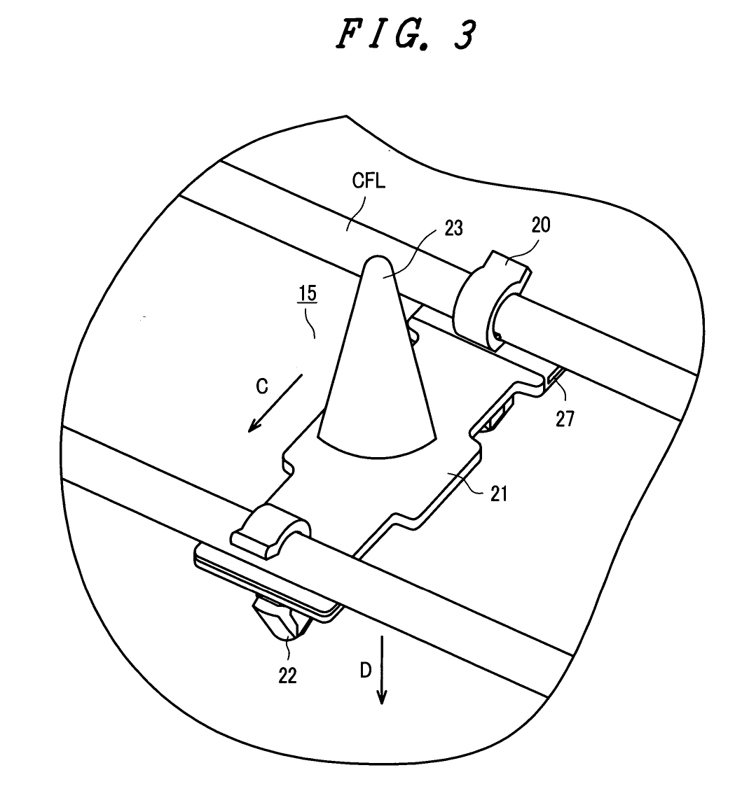

FIG. 3 is an enlarged view of portion A of FIG. 2. As shown in FIG. 3, each cold cathode fluorescent tube (CFL) is fastened by lamp holders 15. Each lamp holder 15 has an anchoring portion 22 (described later) which is fitted into a hole (B in FIG. 2) formed in the reflecting plate 10, whereby the holder is fastened to the reflecting plate 10.

The reflecting plate 10 is made of polyethylene terephthalate (PET). Each lamp holder 15 is made of a polycarbonate (PC) designed to show high reflectivity.

In the case of FIG. 2, two adjacent cold cathode fluorescent tubes (CFLs) are fastened by one lamp holder 15, and two lamp holders 15 are disposed per cold cathode fluorescent tube (CFL). Thus, when a large-sized monitor having a large display screen is used under normal conditions, bending of the cold cathode fluorescent tubes (CFLs) can be prevented.

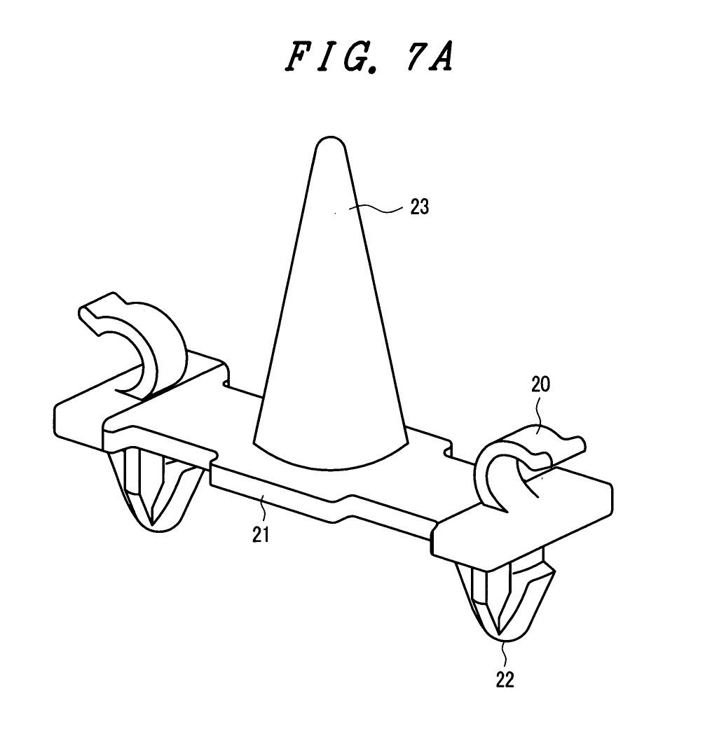

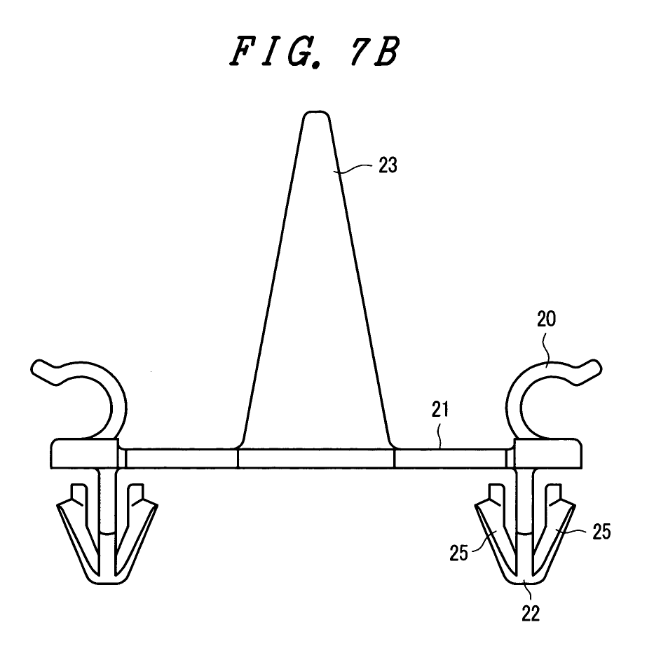

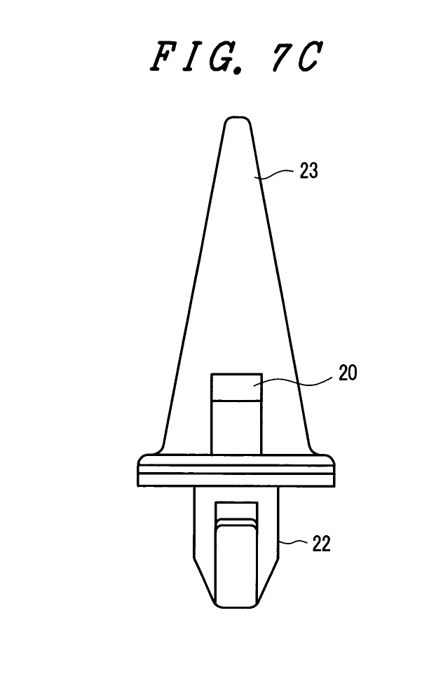

FIG. 7A is a perspective view of the prior art lamp holder 15. FIG. 7B is a front elevation of the prior art lamp holder 15. FIG. 7C is a side elevation of the prior art lamp holder 15.

As shown in FIGS. 7A, 7B, and 7C, the prior art lamp holder 15 has gripping portions 20 for gripping cold cathode fluorescent tubes (CFLs), a connector portion 21 having the gripping portions 20 on its opposite sides, anchoring portions 22 formed on the rear surfaces of the gripping portions 20 of the connector portion 21, and a support portion 23 formed in the center of the connector portion 21.

Each of the anchoring portions 22 has a pair of pawl portions 25. A step portion is formed at the front end of each of the pawl portions 25. The pawl portions 25 are pushed into the holes formed in the reflecting plate 10 until the step portions at the front ends is placed around the holes formed in the reflecting plate 10. Thus, the lamp holder 15 is fastened to the reflecting plate 10.

The support portion 23 maintains the distance to the diffuser plate 11 and prevents the diffuser plate 11 from being warped toward the cold cathode fluorescent tubes (CFLs) due to thermal expansion while the tubes (CFLs) are being lit.

However, in the structure of the prior art lamp holder 15, there is the problem that if an impact is applied under some conditions such as when a product impact test is performed, an impact is applied to the cold cathode fluorescent tubes (CFLs) from the lamp holders 15, whereby the tubes (CFLs) are damaged or broken.

For example, if an impact in the direction of the arrow C (parallel to the longitudinal direction of the connector portion 21) shown in FIG. 3 is applied to the backlight (BL), an impact opposite in direction to the arrow C is applied to the cold cathode fluorescent tubes (CFLs), because they are held by the lamp holders 15. As a result, the fluorescent tubes (CFLs) are broken.

Furthermore, if an impact in the direction of the arrow D (direction directed from the connector portion 21 to the reflecting plate 10) shown in FIG. 3 is applied to the backlight (BL), an impact opposite in direction to the arrow D is similarly applied to the cold cathode fluorescent tubes (CFLs), thus breaking them.

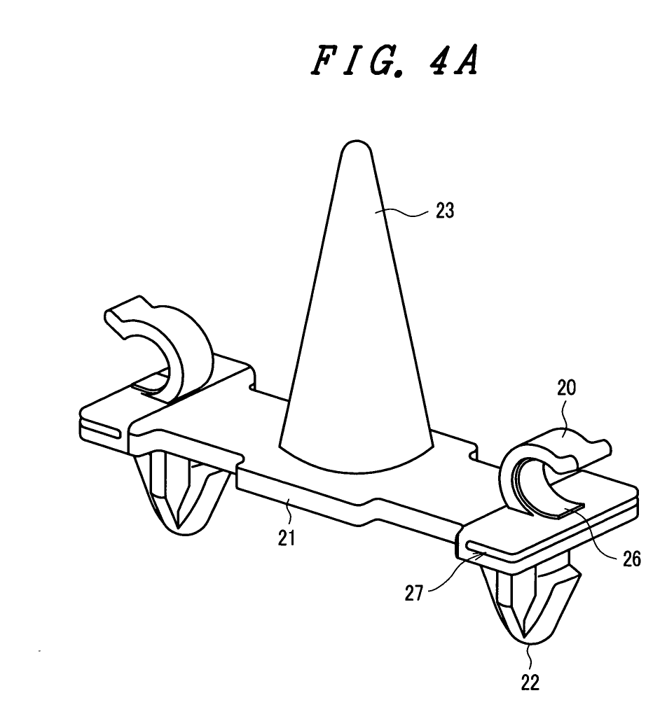

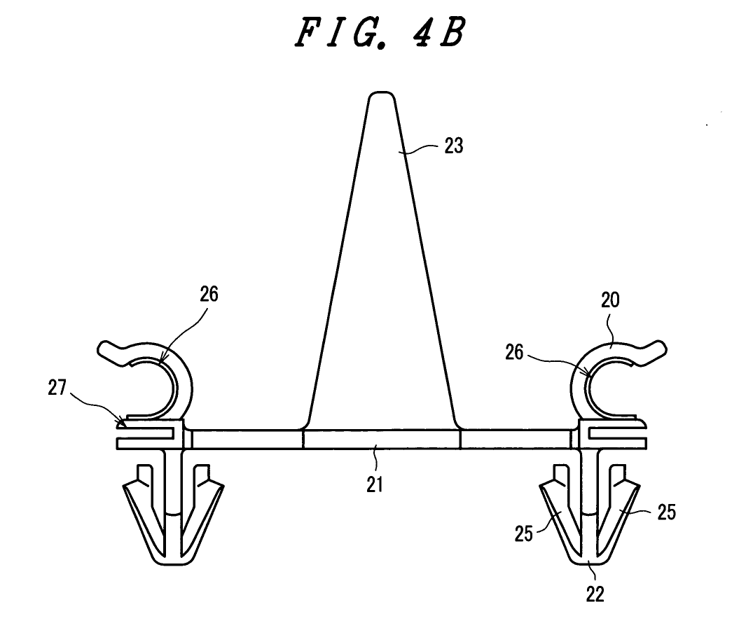

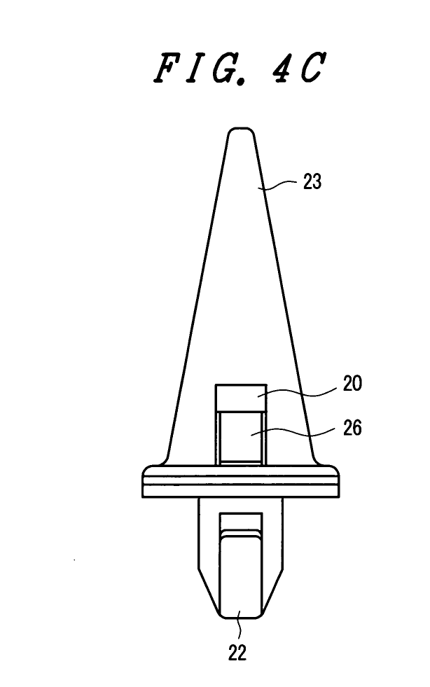

FIGS. 4A-4C are views schematically showing the structure of one lamp holder 15 of the present embodiment. FIG. 4A is a perspective view. FIG. 4B is a front elevation. FIG. 4C is a side elevation. As shown in FIGS. 4A, 4B, and 4C, the lamp holder 15 of the present embodiment is characterized in that a shock-absorbing material 26 is mounted on the inner surfaces of its gripping portions 20 which make contact with cold cathode fluorescent tubes (CFLs), and that resilience is imparted to the lamp holder itself. The shock-absorbing material 26 is made of silicone rubber, for example.

Furthermore, in the lamp holder 15 of the present embodiment, as shown in FIGS. 4A and 4B, a slit 27 is formed between gripping portion 20 and anchoring portion 22 at each end of the lamp holder 15. In this way, resilience is imparted to the lamp holder itself.

Thus, in the present embodiment, when an impact in the aforementioned direction of the arrow C shown in FIG. 3 is applied to the backlight (BL), an impact that is opposite in direction to the arrow C and applied to each cold cathode fluorescent tube (CFL) is absorbed by the shock-absorbing material 26. Consequently, failure of the cold cathode fluorescent tube (CFL) can be prevented.

Similarly, when an impact in the aforementioned direction of the arrow D shown in FIG. 3 is applied to the backlight (BL), the impact that is opposite in direction to the arrow D and applied to the cold cathode fluorescent tube (CFL) is absorbed by the resilience of the lamp holder itself. In consequence, failure of the cold cathode fluorescent tube (CFL) can be prevented.

In the above-cited Patent Reference 1, too, the protruding portions are formed on each lamp holder. When the cold cathode fluorescent tubes (CFLs) are being lit, the diffuser plate 11 is prevented from being warped toward the cold cathode fluorescent tubes (CFLs) due to thermal expansion.

However, the protruding portions of the above-cited Patent Reference 1 are cylindrical. In contrast, the support portions 23 of the present embodiment are conical. In this respect, the lamp holders 15 of the present embodiment are different from the protruding portions of the above-cited Patent Reference 1.

Generally, where the lamp holders 15 are mounted in the backlight as in the present embodiment, the liquid crystal panel 2 suffers from nonuniform brightness. According to results of a discussion made by the present inventor, brightness nonuniformity due to the provision of the lamp holders 15 can be reduced more effectively where the protrusions for preventing the diffuser plate 11 from warping toward the cold cathode fluorescent tubes (CFLs) are shaped conically as in the present invention than where the protrusions are shaped cylindrically as described in the above-cited Patent Reference 1.

In the above description, the support portion 23 is shaped conically. The support portion 23 may also be shaped pyramidally, i.e., the support portion gradually gets thinner from its bottom toward the front end portion.

That is, where the support portion 23 is cut by a plane which passes through the front end portion of the support portion 23 and is perpendicular to the support portion 23, the bottom portion should be made wider than the front end portion that supports the diffuser plate 11.

### Embodiment 2

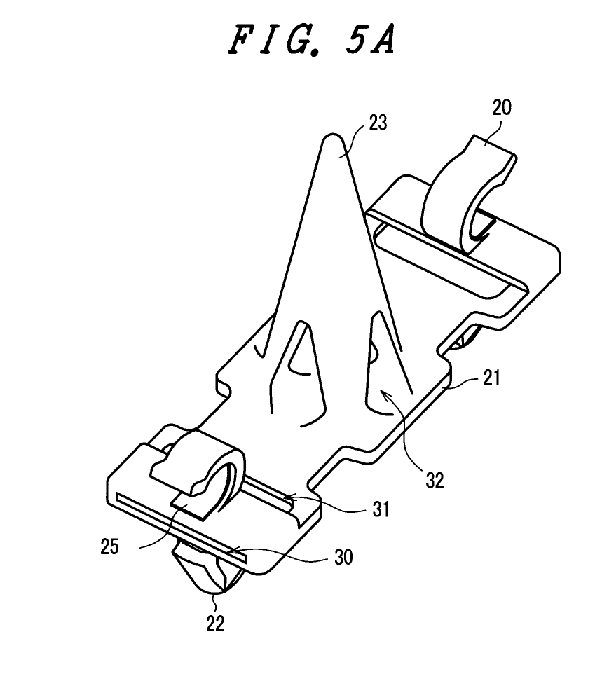

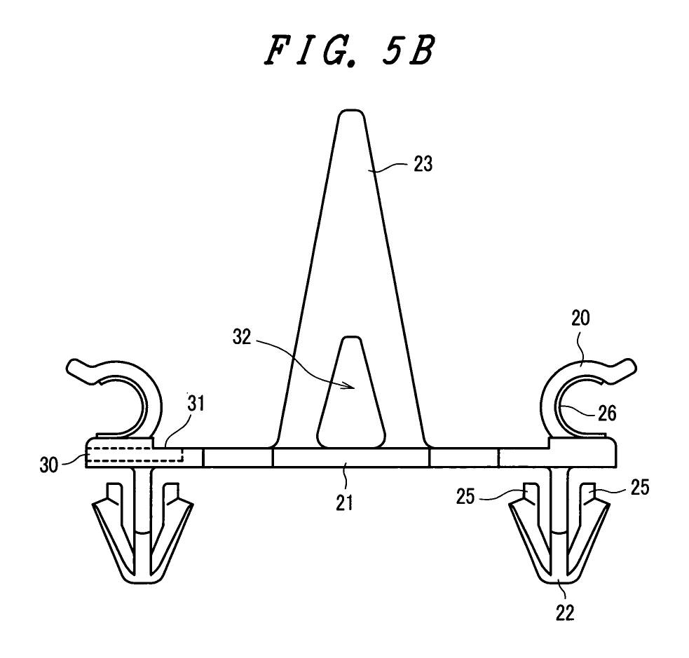

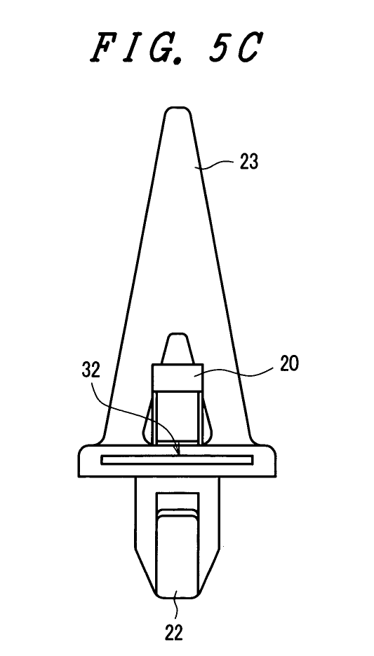

FIGS. 5A-5C are views schematically showing the structure of one lamp holder 15 of embodiment 2 of the present invention. FIG. 5A is a perspective view. FIG. 5B is a front elevation. FIG. 5C is a side elevation. As shown in FIGS. 5A, 5B, and 5C, the lamp holder 15 of the present embodiment also has a shock-absorbing material 26 mounted on the inner surfaces of its gripping portions 20 which make contact with cold cathode fluorescent tubes (CFLs), the shock-absorbing material 26 being made of silicone rubber, for example.

In the lamp holder 15 of the present embodiment, however, as shown in FIGS. 5A and 5B, a hole or slot 30 is formed between the gripping portion 20 and anchoring portion 22 at each end of the lamp holder 15, whereby resilience is imparted to the lamp holder itself. As indicated by numeral 31 in FIGS. 5A and 5B, the slot 30 has a bottom portion that is open on its upper side, i.e., on the side of the support portion 23.

Thus, in the present embodiment, too, when an impact is applied to the backlight (BL) as indicated by C as described above, an impact which is applied to the cold cathode fluorescent tubes (CFLs) and directed oppositely to the arrow C shown in FIG. 3 is absorbed by the shock-absorbing material 26. Hence, the cold cathode fluorescent tubes (CFLs) are prevented from being damaged.

Similarly, when an impact as indicated by D as mentioned previously is applied to the backlight (BL), an impact which is applied to the cold cathode fluorescent tubes (CFLs) and directed oppositely to the arrow D shown in FIG. 3 is absorbed by the resilience of the lamp holder itself. Therefore, the cold cathode fluorescent tubes (CFLs) can be prevented from being damaged.

Furthermore, in the present embodiment, four slits 31 are formed in the bottom portion of the support portion 23 on the side of the connector portion 21 to impart resilience to the support portion itself.

Thus, in the present embodiment, when an impact is applied from the outside, the diffuser plate 11 is prevented from being scratched.

In the above embodiments, the lamp holders 15 are arranged in a zigzag manner with respect to the longitudinal direction of the cold cathode fluorescent tubes (CFLs) to reduce brightness nonuniformity produced on the liquid crystal panel 2.

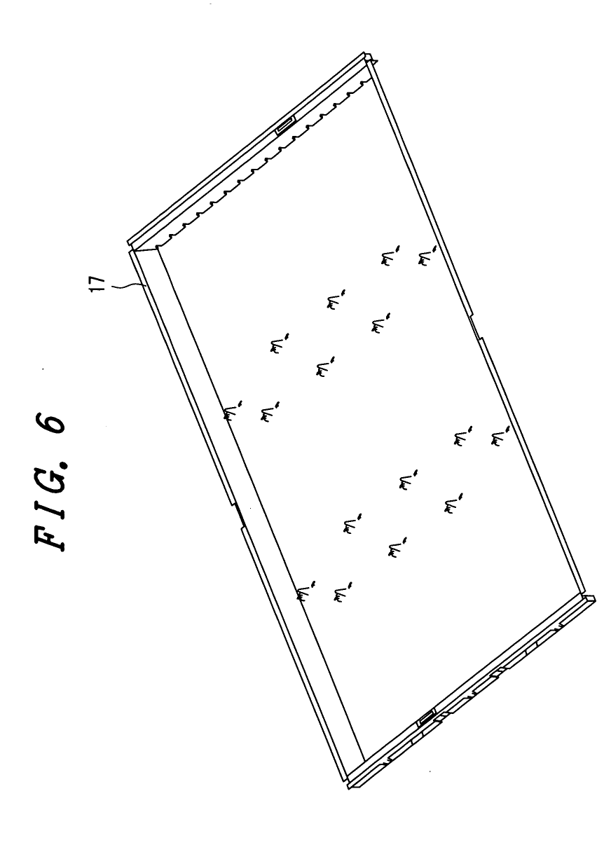

In addition, in the above description, the lamp holders 15 are fastened to the reflecting plate 10. Where a lower molded part 17 shown in FIG. 6 is used instead of the lower frame 3 shown in FIG. 2, the lamp holders 15 may be fastened to the lower molded part 17.

While the invention made by the present inventor has been described in detail based on the embodiments described above, the invention is not limited thereto. Obviously, they can be modified variously without departing from the scope of the invention.

1. A liquid crystal display comprising:
a liquid crystal panel having a display screen; and
a backlight disposed on an opposite side of the display screen of said liquid crystal panel and having plural light sources and plural lamp holders for holding said light sources, each of said lamp holders having a shock-absorbing material on surfaces that make a contact with said light sources.

2. A liquid crystal display comprising:
a liquid crystal panel having a display screen; and
a backlight disposed on an opposite side of the display screen of said liquid crystal panel and having plural light sources and plural lamp holders for holding said light sources, each of said lamp holders having resilience.

3. A liquid crystal display comprising:
a liquid crystal panel having a display screen; and
a backlight disposed on an opposite side of the display screen of said liquid crystal panel and having plural light sources and plural lamp holders for holding said light sources, each of said lamp holders having a pair of gripping portions for gripping said light sources and a connector portion having said gripping portions at its opposite ends, said gripping portions having a shock-absorbing material on surfaces that make a contact with said light sources.

4. A liquid crystal display comprising:
a liquid crystal panel having a display screen; and
a backlight disposed on an opposite side of the display screen of said liquid crystal panel and having plural light sources and plural lamp holders for holding said light sources, each of said lamp holders having a pair of gripping portions for gripping said light sources and a connector portion having said gripping portions at its opposite ends, said connector portion having slits in its opposite end portions, the slits extending longitudinally of said connector portion.

5. A liquid crystal display comprising:
a liquid crystal panel having a display screen; and
a backlight disposed on an opposite side of the display screen of said liquid crystal panel and having plural light sources and plural lamp holders for holding said light sources, each of said lamp holders having a pair of gripping portions for gripping said light sources and a connector portion having said gripping portions at its opposite ends, said connector portion having holes in its opposite end portions, the holes extending longitudinally of said connector portion.

6. A liquid crystal display as set forth in claim 3, wherein said backlight has an optical element, and wherein said connector portion has a support portion that supports said optical element.

7. A liquid crystal display as set forth in claim 6, wherein when said support portion is cut by a plane which passes through a front end portion supporting said optical element and which is perpendicular to said support portion, a bottom portion of said support portion on a side of said connector portion is made wider than said front end portion.

8. A liquid crystal display as set forth in claim 6, wherein said support portion has at least one slit formed in the bottom portion on a side of said connector portion and extending toward the center of said support portion.

9. A liquid crystal display as set forth in in claim 1, wherein said backlight has a reflecting plate, and wherein each of said lamp holders is fastened to said reflecting plate.

10. A liquid crystal display as set forth in in claim 1, wherein said backlight has a lower molded part, and wherein said lamp holders are formed integrally with said lower molded part.

11. A liquid crystal display comprising:
a liquid crystal panel having a display screen; and
a backlight disposed on an opposite side of the display screen of said liquid crystal panel and having an optical element, plural light sources, and plural lamp holders for holding said light sources, each of said lamp holders having a pair of gripping portions for gripping said light sources and a connector portion having said gripping portions at its opposite ends, said connector portion having a support portion supporting said optical element, said support portion having at least one slit formed in a bottom portion of said support portion on a side of said connector portion, said slit extending toward the center of said support portion.

12. A liquid crystal display as set forth in claim 4, wherein said backlight has an optical element, and wherein said connector portion has a support portion that supports said optical element.

13. A liquid crystal display as set forth in claim 5, wherein said backlight has an optical element, and wherein said connector portion has a support portion that supports said optical element.

14. A liquid crystal display as set forth in claim 12, wherein when said support portion is cut by a plane which passes through a front end portion supporting said optical element and which is perpendicular to said support portion, a bottom portion of said support portion on a side of said connector portion is made wider than said front end portion.

15. A liquid crystal display as set forth in claim 13, wherein when said support portion is cut by a plane which passes through a front end portion supporting said optical element and which is perpendicular to said support portion, a bottom portion of said support portion on a side of said connector portion is made wider than said front end portion.

16. A liquid crystal display as set forth in claim 12, wherein said support portion has at least one slit formed in the bottom portion on a side of said connector portion and extending toward the center of said support portion.

17. A liquid crystal display as set forth in claim 13, wherein said support portion has at least one slit formed in the bottom portion on a side of said connector portion and extending toward the center of said support portion.
